(19) United States
(12) Patent Application Publication
(10) Pub. No.: US 2015/0095155 A1
(43) Pub. Date: Apr. 2, 2015

(54) METHOD AND SYSTEM FOR COLLABORATIVE LOCATION DETECTION

(71) Applicant: Yahoo! Inc., Sunnyvale, CA (US)

(72) Inventor: Lars Erik Holmquist, San Francisco, CA (US)

(73) Assignee: Yahoo! Inc., Sunnyvale, CA (US)

(21) Appl. No.: 14/040,987

(22) Filed: Sep. 30, 2013

(51) Int. Cl. H04L 29/08; G06Q 30/02

(52) U.S. Cl. CPC H04L 67/18; G06Q 30/0261
USPC 705/14.58; 709/224

(57) ABSTRACT

Disclosed is a system, method, and computer readable medium for collaboratively detecting location. A computing device detects a client device in communication with the computing device. The computing device requests, from the client device, a location of the client device and receives this location. The computing device performs the detecting, requesting, and receiving steps for each of a plurality of client devices, where the performing occurs for a predetermined number of client devices. The computing device then determines its location from the received locations of the predetermined number of client devices.

### FIELD

The present disclosure relates to location detection, and more specifically to a method and system for collaborative location detection.

### BACKGROUND

Mobile devices such as smartphones and tablets typically include location detection technology. Specifically, the mobile devices can include, for example, GPS and/or wireless signal triangulation to determine its location. When a user uses his or her smartphone to access a web page, the web page may use the user's location (e.g., after requesting approval for such use) to customize the web page displayed for the user based on this location.

### SUMMARY

Unlike mobile devices, most relatively stationary devices such as televisions, set-top boxes, gaming consoles, and/or desktop computers usually do not include location detection technology. Thus, these relatively stationary devices cannot usually determine their location accurately. Even if a relatively stationary device uses its IP address to determine its location, this location is typically a very rough location determination and usually not accurate enough for many applications, such as for providing targeted content to the user.

The present disclosure relates to a system, method, and computer readable storage medium for collaboratively detecting location. In one aspect, a computing device detects a client device in communication with the computing device. The computing device requests, from the client device, a location of the client device and receives this location. The computing device performs the detecting, requesting, and receiving steps for each of a plurality of client devices, where the performing occurs for a predetermined number of client devices. The computing device then determines its location from the received locations of the predetermined number of client devices.

In one embodiment, the computing device transmits its location to a server computer. The computing device can receive targeted information from the server for display, where the targeted information relates to the location of the computing device. The targeted information may include targeted advertisements. In one embodiment, the computing device establishes communications with the client device. In one embodiment, the computing device logs the user of the client device into a web site or web page (e.g., based on the computing device's location and/or based on the detected communication established between the computing device and the client device). The computing device may be a stationary device, a relatively stationary device (e.g., desktop computer or smart TV), and/or a mobile device (e.g., smartphone or tablet).

In one embodiment, the computing device determines its location by averaging the received locations. The computing device may perform the detecting, requesting, and receiving steps for additional client devices after initially determining its location after a predetermined time has elapsed (e.g., a few months, one year, etc.).

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a schematic diagram illustrating a system of a network and devices implementing embodiments of the present disclosure;

FIG. 2A is a flowchart illustrating steps performed by a computing device to collaboratively determine its location in accordance with an embodiment of the present disclosure;

FIG. 2B is a flow diagram illustrating steps performed by a computing device to collaboratively determine its location in accordance with an embodiment of the present disclosure;

FIG. 3 is a block diagram of a computing device transmitting a voting application to client devices in accordance with an embodiment of the present disclosure;

FIG. 4 depicts one example of a schematic diagram illustrating a client device in accordance with an embodiment of the present disclosure; and

FIG. 5 is a block diagram illustrating an internal architecture of a computer in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

The present disclosure is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

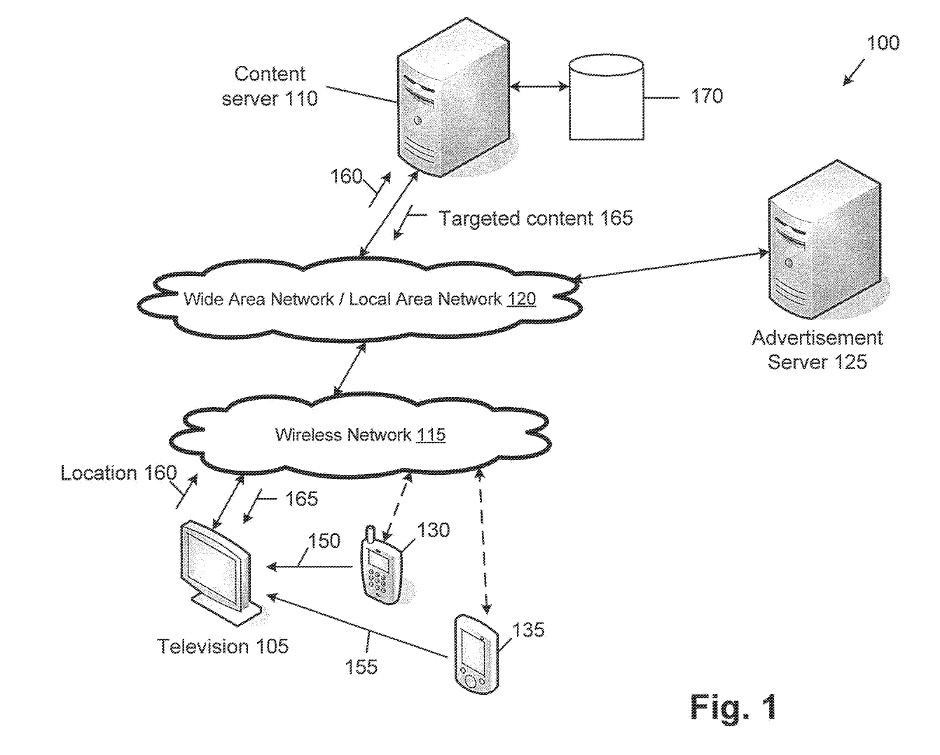

FIG. 1 is a schematic diagram illustrating an example system 100 of a network and devices implementing embodiments of the present disclosure. Other embodiments that may vary, for example, in terms of arrangement or in terms of type of components, are also intended to be included within claimed subject matter. FIG. 1 includes, for example, a television 105 or other wired or wireless viewing device or content receiver (referred to herein as a “television” as a non-limiting example) in communication with a content server 110 over a wireless network 115 connected to a local area network (LAN)/wide area network (WAN) 120, such as the Internet. Content server 110 is also referred to below as server computer 110 or server 110. In one embodiment, the television 105 (and/or server 110) is also in communication with an advertisement server 125. Although shown as a wireless network 115 and WAN/LAN 120, the television 105 can communicate with servers 110, 125 via any type of network.

In one embodiment, the television or viewing device 105 is a “smart” TV that can access the Internet or other wired or wireless network. Although shown and described as a “smart” television, television 105 can be any relatively stationary device, such as a set top box, gaming console (e.g., Xbox 360® developed by Microsoft Corporation®), streaming device, desktop computer, or any other device that can connect to the Internet and does not typically change location (but, in one embodiment, can change location). For example, the relatively stationary device can change location such as during a move to another room in a home, during a move to another home, etc. The relatively stationary device may be juxtaposed in this embodiment to a handheld mobile device or tablet that generally travels with a user wherever they go.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Examples of devices that may operate as a content server include desktop computers, multiprocessor systems, microprocessor-type or programmable consumer electronics, etc. Content server 110 may provide a variety of services that include, but are not limited to, web services, third-party services, audio services, video services, email services, instant messaging (IM) services, SMS services, MMS services, FTP services, voice over IP (VOIP) services, calendaring services, photo services, social media services, or the like. Examples of content may include text, images, audio, video, or the like, which may be processed in the form of physical signals, such as electrical signals, for example, or may be stored in memory, as physical states, for example. In one embodiment, the content server 110 hosts or is in communication with a database 160.

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

A wireless network may couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LIE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

In one embodiment and as described herein, one or more client devices 130, 135 are in communication (e.g., wirelessly or via a cable) with the television 105. The client devices may be any device that can determine its location, such as a smartphone 130, a tablet 135, a PDA, a gaming console controller (e.g., a Wii U® controller developed by Nintendo®), an iPod®, a music player, etc. The client device 130, 135 is, in one embodiment, in the same room as the television 105. The client device 130, 135 can connect with or to the television 105 via, for example, a wireless connection (e.g., WiFi or Bluetooth) or via a wired connection (e.g., Ethernet, USB, etc.)

Each client device 130, 135 determines its location (e.g., periodically, at a set time or times, based on a schedule, on demand, etc.). In one embodiment, the television 105 detects the client device(s) 130, 135 nearby (e.g., within a predetermined distance, such as in the same room). In one embodiment, the television 105 requests the location of each client device 130, 135. The client device 130, 135 transmits its location 150, 155 to the television 105. In one embodiment, the client device 130, 135 automatically transmits its location 150, 155 (e.g., at one or more predetermined times, periodically, etc.) to the television 105. The television 105 can then use the received locations 150, 155 from the nearby mobile devices 130, 135 to determine its location. Although shown with two client devices 130, 135, the television 105 can be in communication with any number of client devices.

The television 105 can determine its location by, for example, computing the average location of some or all of the received locations 150, 155, by computing the mean, median, or mode of the received locations, etc. The television 105 may revise its determination of its location based on locations received after its initial (or, e.g., current) determination of its location. Thus, the television 105 collaboratively detects its location based on locations of client devices within a predetermined distance from the television 105 (e.g., within the same room, within a set distance (e.g., 25 feet) from the television, etc.). As the television 105 does not likely change locations very often, the determined location is unlikely to frequently change.

The television 105 may also detect its location based on if the devices are near enough to be considered co-located, such as if they are in radio distance (through direct connection by WiFi, Bluetooth, etc.), if they are connected with a wired connection (e.g. USB), and/or if they are on the same subnet. This may increase the number of devices that can provide location information, and it makes it possible to start collecting location even when the television 105 does not know its own location.

Once the location for the television 105 has been determined, the television 105 can display targeted advertisements and/or targeted content to the user. In one embodiment, the television 105 communicates its location 160 to the server 110 and the server 110 (and/or server 125) can use this location to transmit targeted content 165 and/or targeted advertisements (e.g., a targeted coupon). For example, the television 105 can determine the address of the house it is located, and the server 110 can then provide local news, local sports, local advertisements, and/or local alerts to the television 105.

In another embodiment, the television 105 can determine which client devices are nearby in order to share data with these client devices. In one embodiment, the server 110 is in communication with a database 170 to, for example, obtain the content 165.

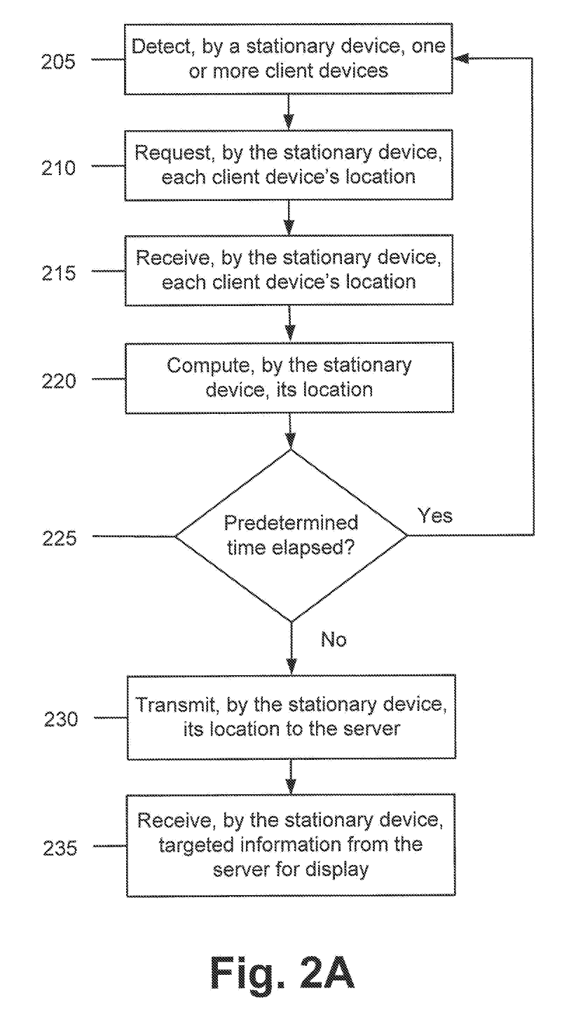

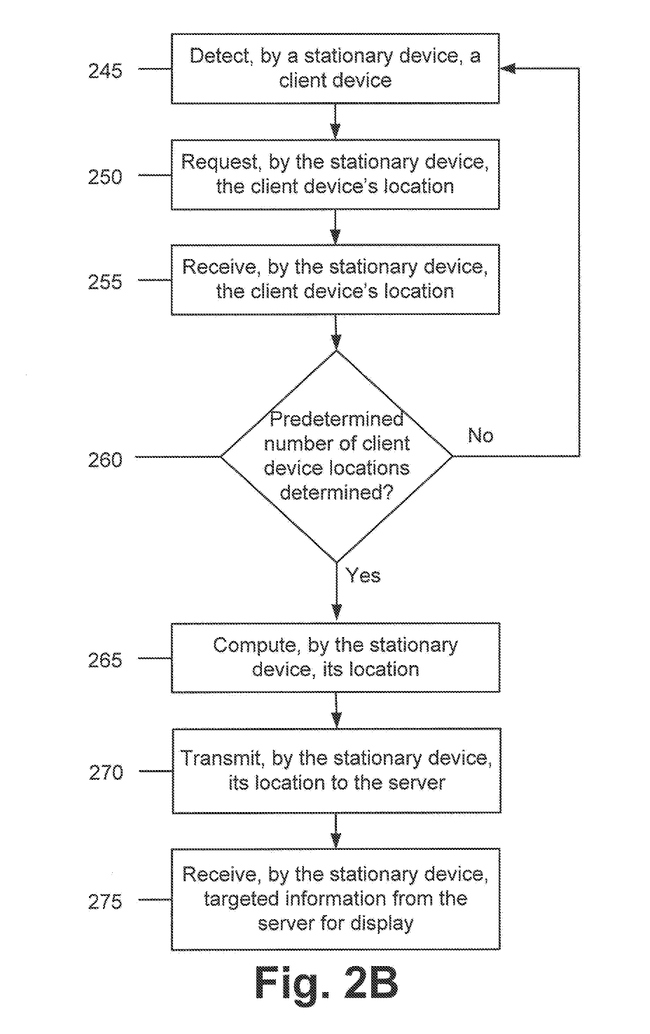

FIG. 2A is a flowchart showing an embodiment of steps performed by a relatively stationary device (referred to below as stationary device 105) such as television 105. The device 105 detects one or more client devices (Step 205). In one embodiment, the stationary device 105 requests each client device's location (Step 210). The stationary device 105 then receives each client device's location (Step 215) and computes its own location 160 (Step 220). In one embodiment, the stationary device 105 needs to receive a predetermined number of client device locations (e.g., three locations) in order to calculate its location 160 with enough accuracy (e.g., within a predetermined threshold level of accuracy).

Once the stationary device 105 calculates its location 160, in one embodiment the stationary device 105 determines if a predetermined time has elapsed (Step 225). In one embodiment, the predetermined time relates to when the stationary device 105 has to check its location 160 again. This predetermined time may be a few days, a few months, one or more year(s), etc. If the predetermined time has elapsed, the stationary device 105 returns to step 205 and executes steps 205-220. If the predetermined time has not elapsed yet, in one embodiment the stationary device 105 transmits its location 160 to server 110 (Step 230). The stationary device 105 can then receive targeted content or information from the server 110 for display or for communication (e.g., to the client device(s)) (Step 235).

Thus, by obtaining multiple data points from multiple connected devices over time, the relatively stationary device 105 can determine its own location with high accuracy. Outliers (e.g., remote connections) can be filtered out, and converging data (e.g., multiple connections from the same device in the same room) will emerge.

Additionally, as the calculated location stabilizes, in one embodiment the stationary device 105 can stop collecting data from client devices, and can perform occasional checks in order to verify that the stationary device 105 has not moved. If there is a significant event (such as a change in IP address, which indicates a large move, or if the stationary device 105 has been disconnected from the Internet for a period of time above a threshold), the stationary device 105 can re-start the location data gathering in order to establish its new location.

Several examples of when stationary device 105 can gather location data include when a location-aware client device such as a phone 130 or tablet 135 is used as a remote control, whenever a client device is used as a “second screen” (e.g., via the IntoNow® application provided by Yahoo!®), when communication(s) occurs between a client device and the stationary device 105, and/or whenever a client device is used to download additional information, such as a coupon.

In one embodiment, the relatively stationary device is a desktop computer. The desktop computer can determine its location whenever a client device (e.g., a smartphone or tablet) is connected to or in communication with the desktop computer. For example, the desktop computer may determine its location when a client device is connected to the desktop computer to perform a backup or when the client device is used to upload or download media, such as music or pictures.

In one embodiment, the location determination of the relatively stationary device 105 is an iterative process—the device 105 builds up data to increase the accuracy of its location determination. In this iterative process, the device 105 may have a cutoff time or amount of data at which, once elapsed or once gathered, stops the process.

Thus, the above description enables a relatively stationary device to determine its location much more accurately than the relatively stationary device currently can without a modification of its existing hardware. Specifically, conventional devices that are relatively stationary can determine their location indirectly via its IP address. This technique is often inaccurate, with a determination of location in the region of miles or worse (e.g., at the zip code level). The above collaborative location determination technique enables a relatively stationary device to determine its location much more accurately (e.g., down to a couple of yards) without modification of its hardware.

In one embodiment, once the relatively stationary device (e.g., television 105) determines its location, the device can determine when a mobile client device 130, 135 is in the same room as the television 105. The television 105 can then make an automatic connection between the client device 130, 135 and the television 105. Thus, with a second screen application (e.g., IntoNow®), the television 105 and client device 130, 135 can communicate information back and forth, thereby enabling the television 105 to, e.g., obtain user information of the user using the second screen application. Thus, two-way communications are enabled between the television 105 and the client device 130, 135. The client device 130, 135 can send (e.g., after user approval or automatically) the user's profile to the television 105. This may enable communications between the television 105 and the client device 130, 135 to occur automatically. In one embodiment, the user can log into a web page via the television 105 via his or her user profile.

FIG. 2B illustrates another embodiment of steps performed by the stationary device. As described above, the stationary device 105 detects a client device (Step 245), requests the client device's location (Step 250), and receives the client device's location (Step 255). In one embodiment, the stationary device then determines whether a predetermined number of client device locations have been determined (Step 260). This predetermined number may be set (e.g., by the manufacturer of the stationary device, by the user or owner of the stationary device, etc.) to obtain an accurate determination of its location. If the predetermined number of client device locations (e.g., three locations) has not been determined, Steps 245-255 are repeated for another client device. If the stationary device 105 determines that the predetermined number of client device locations have been determined/received, the stationary device 105 computes its location (Step 265). As indicated above, in one embodiment the stationary device 105 can transmits its location to a server 110 (Step 270) and receive targeted information from the server 110 (Step 275).

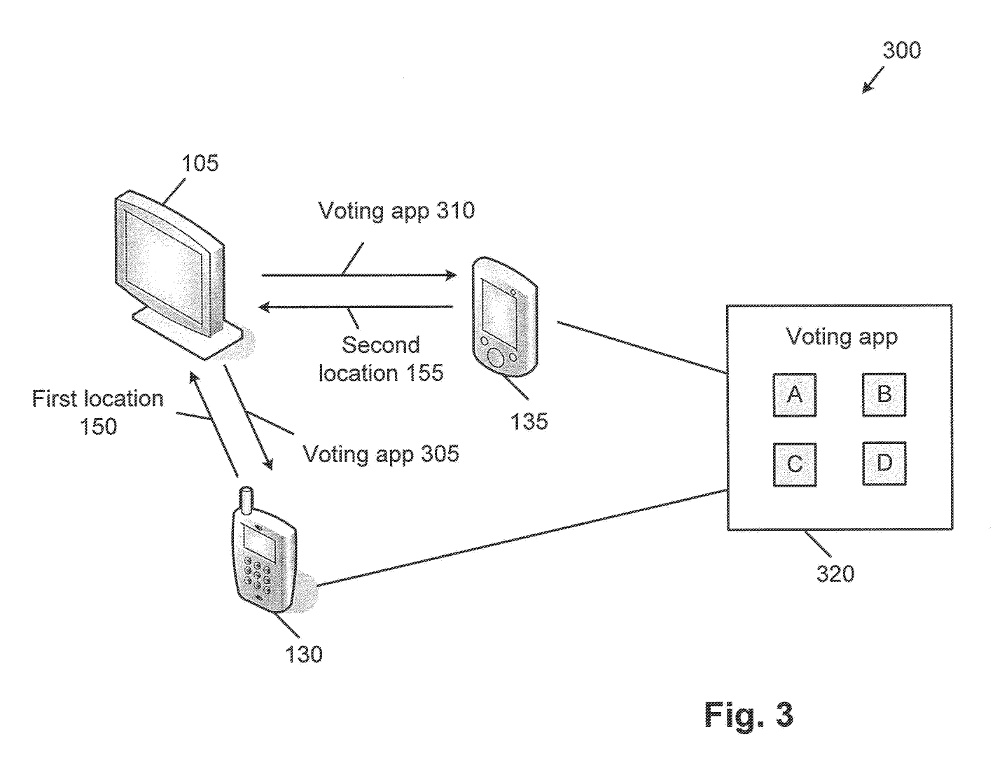

Referring to FIG. 3, as described above, the first client device 130 transmits its first location 150 to the television 105 and the second client device 135 transmits its second location 155 to the television 105. As described above, the television 105 determines its location from the received first and second locations 150, 155. In one embodiment, the television 105 then transmits a voting application (also referred to herein as voting app) 305, 310 to the client devices 130, 135. In one embodiment, the television 105 communicates the voting app 305, 310 to the client devices 130, 135 when the television 105 determines that this app would apply to the particular program being displayed by the television 105, such as for example American Idol® or X Factor®. In one embodiment, each client device 130, 135 displays the voting app 305, 310, as shown in display screen 320. The voting app 305, 310 in this example presents four choices, A, B, C, and D. The user of each client device 130, 135 can “vote” for a choice and, once the selection is made, the client device 130, 135 communicates the selection back to the television 105. Thus, instead of the conventional approach of requiring an individual to call a specific telephone number to vote for a particular contestant on one of these talent TV programs (e.g., American Idol® or X Factor®), the television 105 can use its determined location with the client devices 130, 135 to enable voting through voting app 305, 310.

In another embodiment, the television 105 can use its determined location to communicate what is being displayed by the television 105 to a second screen application displayed by one or more client devices 130, 135. Thus, unlike conventional second screen apps, which obtain the audio from the TV and determine the program being displayed by the TV from this audio, the television 105 can provide this information to the second screen app because the television 105 has determined its location and can obtain this broadcast information from the server 110. Therefore, less processing occurs on the client devices 130, 135. Further, due to the communication link established between a client device 130, 135 and the television 105, the television 105 may transmit additional information to the second screen app, such as local sports scores.

Although described as a voting app, the television 105 can send clues or a question/answer interface to the client device 130, 135, such as if a game show is being displayed by the television 105. Further, in one embodiment, if the television 105 is displaying a sporting event such as the Olympics or a football game, the television 105 could display one event (track and field or one football game) and could transmit a second event to the client device 130, 135 (e.g., gymnastics or a second football game) after establishing the connection with the client device 130, 135.

In one embodiment, the television 105 can log a user into an online account much more easily than is currently done. For example, if the television 105 determines that Person Z is watching a program based on a connected client device 130, the television 105 may “ask” Person Z if they are Person Z based on the user profile on the client device 130. In another embodiment, the television 105 can log Person Z into a web account (e.g., Yahoo!®) automatically.

Thus, the connection(s) established between the television 105 and the client device(s) 130, 135 can occur even if the client devices 130, 135 are on different networks. For example, suppose Person A goes to Person B's house. Person A does not connect to person B's network via WiFi. Instead, Person A uses his or her 3G connection and connects via, e.g., Verizon. In this case, Person A has an IP address that does not accurately represent their location. Once the television 105 has determined its location, however, the television 105 can determine that Person A's client device 130 is near the television 105. Therefore, the television 105 can still transmit local or targeted content to the client device 130 of Person A.

In one embodiment, the television 105 can determine the user profiles of client devices and then, when a new client device connects to the television, the television 105 can transmit a communication to the new client device that asks the user of the new client device whether he or she knows a particular person based on them being in the same location (at the same time or at different times) or by having a similar user profile. In one embodiment, the television 105 can transmit an indication for users of client devices to connect in one or more social networks based on one or more factors (e.g., user profile matching, locations, etc.).

As indicated above, in one embodiment a targeted coupon can be displayed on the client device 130, 135. Typically, a user sees an advertisement and then has to log into a particular web site to type in a code that the user had previously obtained. Once this code is entered, the user will often receive the coupon as a text message. Unlike this conventional approach, in one embodiment the television 105 can determine that it is showing a coupon. The television 105 can also determine that a client device is in the same room as the television 105 (based on its determined location). The television 105 can automatically send the coupon to the client device once the television 105 determines that the client device is in the same room as the television 105.

In one embodiment, any device can use this collaborative location detection technique to better determine (e.g., more accurately determine) its location. For example, in one embodiment a mobile device can collaboratively determine its location (e.g., as a check on its internal location determining components and software or to further refine the location determination) from other mobile devices or stationary devices (e.g., relatively stationary devices) that are nearby and that are in communication with the mobile device.

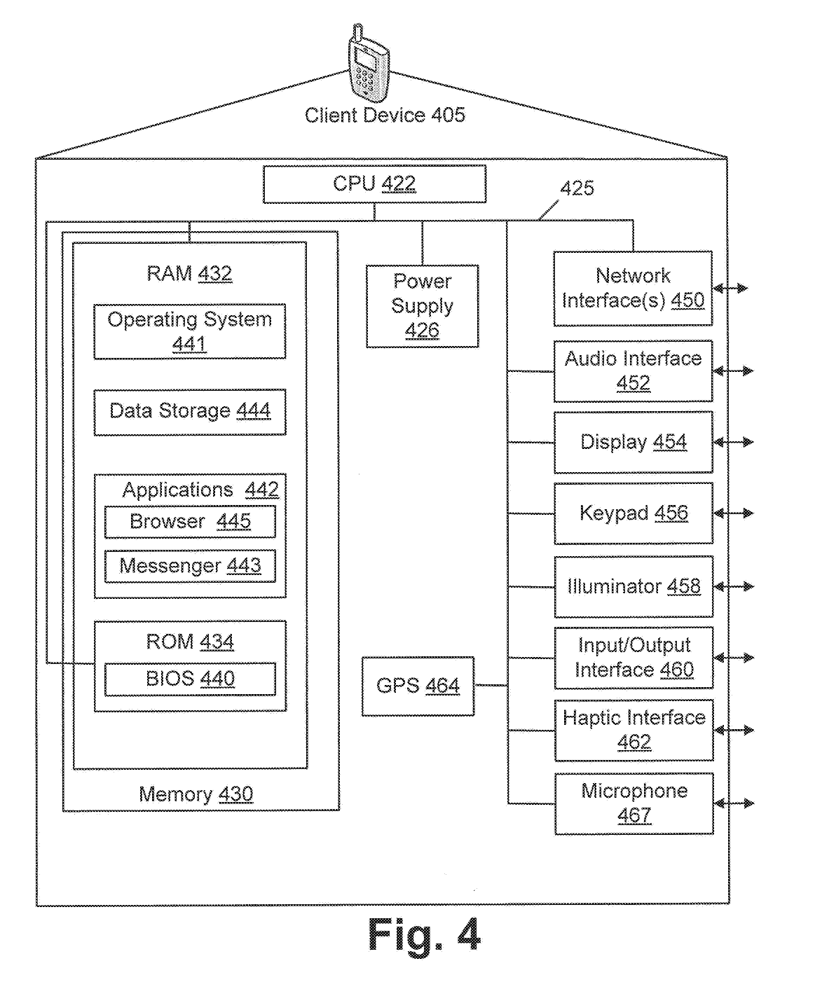

As shown in the example of FIG. 4, client device 405 may include one or more processing units (also referred to herein as CPUs) 422, which interface with at least one computer bus 425. A memory 430 can be persistent storage and interfaces with the computer bus 425. The memory 430 includes RAM 432 and ROM 434. ROM 434 includes a BIOS 440. Memory 430 interfaces with computer bus 425 so as to provide information stored in memory 430 to CPU 422 during execution of software programs such as an operating system 441, application programs 442, device drivers, and software modules 443, 445 that comprise program code, and/or computer-executable process steps, incorporating functionality described herein, e.g., one or more of process flows described herein. CPU 422 first loads computer-executable process steps from storage, e.g., memory 432, data storage medium/media 444, removable media drive, and/or other storage device. CPU 422 can then execute the stored process steps in order to execute the loaded computer-executable process steps. Stored data, e.g., data stored by a storage device, can be accessed by CPU 422 during the execution of computer-executable process steps.

Persistent storage medium/media 444 is a computer readable storage medium(s) that can be used to store software and data, e.g., an operating system and one or more application programs. Persistent storage medium/media 444 can also be used to store device drivers, such as one or more of a digital camera driver, monitor driver, printer driver, scanner driver, or other device drivers, web pages, content files, playlists and other files. Persistent storage medium/media 444 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Client device 405 can also include one or more of a power supply 426, network interface 450, audio interface 452, a display 454 (e.g., a monitor or screen), keypad 456, illuminator 458, I/O interface 460, a haptic interface 462, a GPS 464, a microphone 466, a video camera, TV/radio tuner, audio/video capture card, sound card, analog audio input with A/D converter, modem, digital media input (HDMI, optical link), digital I/O ports (RS232, USB, FireWire, Thunderbolt), expansion slots (PCMCIA, ExpressCard, PCI, PCIe).

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

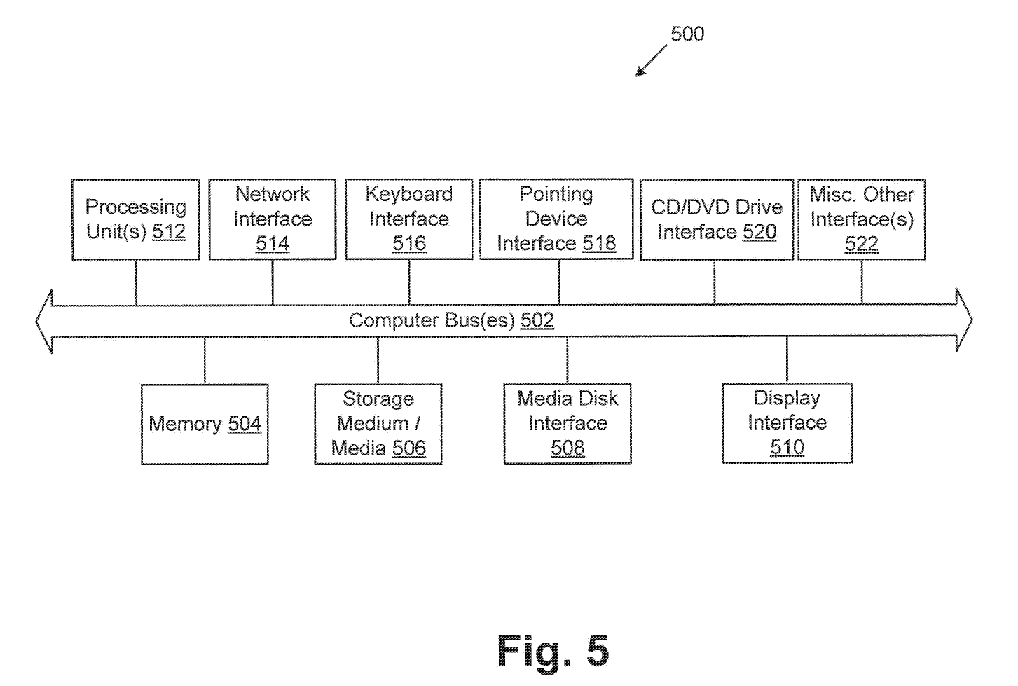

FIG. 5 is a block diagram illustrating an internal architecture of an example of a computer, such as a server computer and/or a client device and/or a stationary device, in accordance with one or more embodiments of the present disclosure. A computer as referred to herein refers to any device with a processor capable of executing logic or coded instructions, and could be a server, personal computer, set top box, tablet, smart phone, pad computer or media device, to name a few such devices. As shown in the example of FIG. 5, internal architecture 500 includes one or more processing units (also referred to herein as CPUs) 512, which interface with at least one computer bus 502. Also interfacing with computer bus 502 are persistent storage medium/media 506, network interface 514, memory 504, e.g., random access memory (RAM), run-time transient memory, read only memory (ROM), etc., media disk drive interface 508 as an interface for a drive that can read and/or write to media including removable media such as floppy, CD-ROM, DVD, etc. media, display interface 510 as interface for a monitor or other display device, keyboard interface 516 as interface for a keyboard, pointing device interface 518 as an interface for a mouse or other pointing device, and miscellaneous other interfaces not shown individually, such as parallel and serial port interfaces, a universal serial bus (USB) interface, and the like.

Memory 504 interfaces with computer bus 502 so as to provide information stored in memory 504 to CPU 512 during execution of software programs such as an operating system, application programs, device drivers, and software modules that comprise program code, and/or computer-executable process steps, incorporating functionality described herein, e.g., one or more of process flows described herein. CPU 512 first loads computer-executable process steps from storage, e.g., memory 504, storage medium/media 506, removable media drive, and/or other storage device. CPU 512 can then execute the stored process steps in order to execute the loaded computer-executable process steps. Stored data, e.g., data stored by a storage device, can be accessed by CPU 512 during the execution of computer-executable process steps.

As described above, persistent storage medium/media 506 is a computer readable storage medium(s) that can be used to store software and data, e.g., an operating system and one or more application programs. Persistent storage medium/media 506 can also be used to store device drivers, such as one or more of a digital camera driver, monitor driver, printer driver, scanner driver, or other device drivers, web pages, content files, playlists and other files. Persistent storage medium/media 506 can further include program modules and data files used to implement one or more embodiments of the present disclosure.

Internal architecture 500 of the computer can include (as stated above), a microphone, video camera, TV/radio tuner, audio/video capture card, sound card, analog audio input with A/D converter, modem, digital media input (HDMI, optical link), digital I/O ports (RS232, USB, FireWire, Thunderbolt), and/or expansion slots (PCMCIA, ExpressCard, PCI, PCIe).

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the user computing device or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
detecting, by a first device comprising a processor, a client device in communication with the first device;
requesting, by the first device from the client device, a location of the client device;
receiving, by the first device, the location of the client device;
performing the detecting step, the requesting step, and the receiving step for each of a plurality of client devices, the performing occurring for a predetermined number of client devices in the plurality; and
determining, by the first device, its location from the received locations of the predetermined number of client devices.

2. The method of claim 1, further comprising transmitting, by the first device, its location to a server computer.

3. The method of claim 2, further comprising receiving, by the first device, targeted information from the server for display, the targeted information relating to the location of the first device.

4. The method of claim 3, wherein the receiving of the targeted information further comprises receiving targeted advertisements.

5. The method of claim 1, further comprising communicating, by the first device, log in credentials of a user of the client device to a server computer to log the user into a web site.

6. The method of claim 1, further comprising establishing, by the first device, communications with the client device.

7. The method of claim 1, wherein the first device comprises a relatively stationary device.

8. The method of claim 1, wherein the first device comprises a mobile device.

9. The method of claim 1, wherein the determining of the location from the received locations further comprises averaging the received locations.

10. The method of claim 1, wherein the performing of the detecting step, the requesting step, and the receiving step for each of a plurality of client devices further comprises determining whether a predetermined time has elapsed.

11. A computing device comprising:
a processor;
a storage medium for tangibly storing thereon program logic for execution by the processor, the program logic comprising:
detecting logic executed by the processor for detecting a client device in communication with the processor;
requesting logic executed by the processor for requesting, from the client device, a location of the client device;
receiving logic executed by the processor for receiving the location of the client device;
performing logic executed by the processor for performing the detecting step, the requesting step, and the receiving step for each of a plurality of client devices, the performing occurring for a predetermined number of client devices in the plurality; and
determining logic executed by the processor for determining its location from the received locations of the predetermined number of client devices.

12. The computing device of claim 11, further comprising transmitting logic executed by the processor for transmitting its location to a server computer.

13. The computing device of claim 12, further comprising second receiving logic executed by the processor for receiving targeted information from the server for display, the targeted information relating to the location of the computing device.

14. The computing device of claim 13, wherein the second receiving logic for receiving the targeted information further comprises third receiving logic for receiving targeted advertisements.

15. The computing device of claim 11, further comprising communicating logic executed by the processor for communicating log in credentials of a user of the client device to a server computer to log the user into a web site.

16. The computing device of claim 11, further comprising communication establishing logic executed by the processor for establishing communications with the client device.

17. The computing device of claim 11, wherein the determining logic for determining the location from the received locations further comprises computing logic executed by the processor for averaging the received locations.

18. The computing device of claim 11, wherein the performing logic for performing the detecting step, the requesting step, and the receiving step for each of a plurality of client devices further comprises second determining logic for determining whether a predetermined time has elapsed.

19. A non-transitory computer readable storage medium tangibly storing computer program instructions capable of being executed by a computer processor, the computer program instructions defining the steps of:
detecting, by the computer processor, a client device in communication with the computer processor;
requesting, by the computer processor from the client device, a location of the client device;
receiving, by the computer processor, the location of the client device;
performing, by the computer processor, the detecting step, the requesting step, and the receiving step for each of a plurality of client devices, the performing occurring for a predetermined number of client devices in the plurality; and
determining, by the computer processor, its location from the received locations of the predetermined number of client devices.

20. The non-transitory computer readable storage medium of claim 19, further comprising receiving, by the computer processor, targeted information from a server for display, the targeted information relating to the location of the computer processor.
